(19) United States
(12) Patent Application Publication
(10) Pub. No.: US 2010/0313488 A1
(43) Pub. Date: Dec. 16, 2010

(54) Adjustable after-market sash window stop

(76) Inventors: Luke Liang, S. Plainfield, NJ (US); David Chen, Guangzhou (CN)

Correspondence Address: Thomas A. O'Rourke;Bodner & O'Rourke, LLP, Suite 108, 425 Broadhollow Road, Melville, NY, 11747, US

(21) Appl. No.: 12/802,640

(22) Filed: Jun. 10, 2010

Related U.S. Application Data
(63) Continuation-in-part of application No. 12/456,347, filed on Jun. 15, 2009.
(60) Provisional application No. 61/217,365, filed on May 29, 2009.

(51) Int. Cl. E05C 3/14; E05C 3/12; E06B 3/44; B23Q 17/00

(52) U.S. Cl. 49/506; 292/195; 292/220; 29/407.09

(57) ABSTRACT

An adjustable stop is adapted to limit travel of a sliding sash window/door, and can be installed upon the window/door master frame during initial manufacturing of the product, or may be an after-market option added at some time after manufacturing was completed. The stop may even be installed upon sash windows/doors currently in service in a building. The stop is intended to limit sash travel between a closed position and a safe position, where the safe position is a position significantly less than a full-open position. The safety stop may be comprised of a housing and a tumbler being pivotally mounted within a cavity in the housing, with a spring to bias the tumbler out of an opening in the housing. Mounting is by a flange extending from the housing, with spacers of varying thickness that are capable of removably attaching thereon to accommodate sash to master frame height differences.

### CROSS REFERENCES TO RELATED APPLICATIONS

This application is a continuation-in-part of U.S. patent application Ser. No. 12/456,347, titled “Single Action Vent Stop,” filed Jun. 15, 2009, which claims priority on U.S. Provisional Application Ser. No. 61/217,365, filed May 29, 2009, the disclosures of which are hereby incorporated by reference.

### FIELD OF THE INVENTION

The present invention relates to improvements in safety latches for sliding sash windows and doors, and more particularly to a safety latch which permits after-market installation on a variety of different window configurations, and is capable of preventing accidental egress of a small child from a window.

### BACKGROUND OF THE INVENTION

A sash window or sash door is comprised of a master frame that permits installation into a wall of a home or other building. The master frame is generally arranged to receive at least one sliding member, with the sliding member being in the form of a window or door member that is encased within its own frame. The sliding door or window may contain multiple panes of glass that are separated and supported by muntin bars, or alternatively, a single glazing may be used, to which may be added a decorative artificial muntin grid that simulates the look of the multi-paned window.

Sliding sash windows and doors may be designed to slide horizontally or vertically within the master frame. In addition, sash windows and doors may be provided in the form of a single-hung or a double-hung arrangement. In the single hung arrangement, there may be one sash window member that is fixed within the master frame and a second sash window member that slides relative to the first sash window member. In the double hung arrangement, both sash window members may be permitted to slide relative to the master frame.

Historically, these sliding sash windows were provided with a single latching mechanism, which permitted a person to lock the window in a closed position, or to unlock the window and permit free movement of a sash from one end of the master frame to the other end of the master frame. Safety concerns, in terms of preventing the unauthorized entry of burglars through open windows or other intruders threatening the security of occupants, has led to the introduction of a secondary latching mechanism on many new windows that may be deployed to selectively limit the travel of the sash, once the primary latch has been toggled to unlock the window sashes. One example is shown by U.S. Pat. No. 6,854,214 to Polowinczak for “Stop for a Slidable Window.” This sash window stop, and other similar stops, is designed to be disposed within a cavity in the manufactured sash window frame, whereby a portion of the stop may be toggled to protrude outward and limit the travel of a sash.

The drawback for these window stops is that they are not conducive for after-market installation into a sash window. The window stop disclosed herein provides a unique means of installing such a travel limiting latch onto an existing sash window. The stop herein does not require creation of a cavity in the sash window frame, and may furthermore be easily modified to accommodate various different sash window configurations.

### OBJECTS OF THE INVENTION

It is an object of the invention to provide a means of preventing accidental egress of a child out of a sliding sash window or sash door.

It is an object of the invention to provide a travel limiting stop for a sliding sash window or sash door.

It is another object of the invention to provide a sliding sash window stop that may be installed onto a window after manufacturing of the window is completed.

It is a further object of the invention to provide a sliding sash window stop that may be easily installed onto a window that is already in use in a building.

It is another object of the invention to provide a window stop that may be installed onto many different sash window configurations.

It is also an object of the invention to provide a means of quickly adjusting the stop to accommodate different depths of sash window insets within a master window frame.

Further objects and advantages of the invention will become apparent from the following description and claims, and from the accompanying drawings.

### SUMMARY OF THE INVENTION

The after-market safety stop disclosed herein is intended for attachment to a master frame of a sliding sash window assembly or a sliding sash door assembly, to be capable of limiting sash travel between a closed position and a safe position, where the safe position is a sash position between the closed sash position and a full-open sash position. The safe position may be established to permit sash movement sufficient for ventilation, but be small enough to prevent window sash travel of a magnitude that would allow a small child to accidentally fall out of the opened window. The safety stop may be attached to older windows already installed in a building, because they lack such a stop, or even where they have a safety stop, but it permits travel that is excessive or insufficient in comparison with the needs of the occupant.

The safety stop may be comprised of a multi-walled housing that has a cavity and several openings. A tumbler may be pivotally disposed into the housing cavity, with a portion of the first end of said tumbler protruding out from said one opening in the housing top end, and with the tumbler pivoting at a point between its first end and second end.

The tumbler may be biased by a biasing member, which may essentially be a torsion having arms that are adapted to be held within the housing and the tumbler. The biasing member may be set to bias the tumbler to pivot out from the housing cavity. The tumbler may also be capable of occupying four different positions, two of which may be considered to be transient positions. The tumbler may be placed in a first position, where a tumbler bearing surface may limit movement of a sash member between a closed position and a safe position, or in a second position, where the sash member be able to move past the tumbler, by deflecting the tumbler into an intermediate position, where it may be retained until the sash member is moved back towards the closed past enough to be clear of the safety stop. The tumbler may occupy a second transient position—a retracted position, when the tumbler is toggled between the first and second position.

A mounting flange may be integral to the housing, and protruding outward therefrom, at a position between a top end and a bottom end of the housing, with the mounting flange being generally parallel to the housing bottom end, but offset therefrom by a certain amount. The mounting flange may comprise two or more orifices usable for mounting the safety stop to the sash window or door.

The bottom surface of the mounting flange may also contain two or more orifices for receiving two or more posts to attach a spacer block to the safety stop. The spacer block may be capable of nesting within the mounting flange bottom surface, and may remain therein because of a friction fit between the posts and orifice. Alternatively, the posts may snap into the orifices through the use of a detent. The spacer blocks may have a thickness to adjust for variations in a height difference between said sliding sash and said master frame. Using different thicknesses for the spacer and combinations of different spacers may permit accommodation of for various manufacturers of a sliding sash window assembly or a sliding sash door assembly.

### BRIEF DESCRIPTION OF THE DRAWINGS

FIG. 1 is a front view of a vertical sliding sash window assembly installed in a building, with the adjustable after-market stop of the current invention installed thereon to limit upward travel of the lower sash window.

FIG. 2 is a section cut through the sliding sash window and adjustable stop of FIG. 1.

FIG. 3 is a perspective view of the adjustable window stop of the current invention.

FIG. 4 is a side view of the adjustable window stop of the current invention.

FIG. 5 is a top view of the adjustable window stop of the current invention.

FIG. 6 is a side view of the adjustable window stop of the current invention.

FIG. 7 is a perspective view of the tumbler of the safety stop of the current invention.

FIG. 8 is a perspective view of the biasing member of the safety stop of the current invention.

FIG. 9 is a top perspective view of one embodiment of a spacer block.

FIG. 10 is a bottom perspective view of the spacer block of FIG. 19.

FIG. 11 is a section cut through the spacer block of FIG. 19.

FIG. 12A is a front view of the window stop housing.

FIG. 12B is a top view of the window stop housing of FIG. 4A.

FIG. 12C is a bottom view of the window stop housing of FIG. 4A.

FIG. 12D is a left end view of the window stop housing of FIG. 4A.

FIG. 12E is a right end view of the window stop housing of FIG. 4A.

FIG. 13 is the bottom view of FIG. 12D, but enlarged to show the housing contour features that interact with the biasing member.

FIG. 14 an enlarged perspective view of the housing contour features of FIG. 13, with the two positions of the biasing member illustrated thereon—Safe (A) and Non-safe (B), as well as motion in between, including two temporary positions (B & D) in which the tumbler is retracted.

FIG. 15 is a series of schematic representations showing the positional changes (A, B, C, and D) of the post of the biasing member, relative to the housing contour of the underside of the top housing wall.

FIG. 16 is the view of FIG. 13, but enlarged to show the housing contour features, and with the post of the biasing member shown in a position (“A”) relative to the contour that the post occupies when the tumbler is in the safe position.

FIG. 17 is the view of FIG. 16, but with the post of the biasing member shown in a position (“B”) relative to the contour that the post occupies when the tumbler is in the retracted position, as the tumbler is being toggled from the safe to the unsafe position.

FIG. 18 is an enlarged view of FIG. 17, but with the post of the biasing member shown in a position (“C”) relative to the contour that the post occupies when the tumbler is in the un-safe position.

FIG. 19 is the view of FIG. 18, but with the post of the biasing member shown in a position (“D”) relative to the contour that the post occupies when the tumbler h is in the retracted position, as the tumbler is being toggled from the unsafe to the safe position.

FIG. 20 is an exploded view of the parts comprising the safety stop assembly of the current invention and three spacer blocks.

FIG. 21 is the perspective view of FIG. 12.

FIG. 22 is a perspective view of the safety stop assembly of the current invention and two screws, prior to installation, and being shown in relation to a perspective view of a sliding sash window and master frame to which the stop is to be secured.

FIG. 23 is a side view of the adjustable after-market window stop of the current invention, shown with the tumbler in the first (fully extended, blocking) position.

FIG. 24 is a side view of the adjustable after-market window stop of the current invention, shown with the tumbler in the retracted position.

FIG. 25 is a side view of the adjustable after-market window stop of the current invention, shown with the tumbler in the second position, and with a sash contacting the curved tumbler surface ready to deflect the tumbler out of its path.

FIG. 26 is a side view of the adjustable after-market window stop of the current invention, shown with the tumbler in the intermediate position.

FIG. 27 is the section cut of FIG. 2, enlarged and showing need for an after-market stop with three spacer blocks for a window with a sash member co-planer with the master frame.

FIG. 28 is the section cut of FIG. 34, showing the same after-market stop with two spacers for a window with a sash member being slightly offset from the master frame.

FIG. 29 is the section cut of FIG. 35, showing the same after-market stop but with only one spacer, for a window with a sash member having a larger offset from the master frame than the window of FIG. 35.

FIG. 30 is the section cut of FIG. 36, showing the same after-market stop but with no spacers, for a window with a sash member having a larger offset from the master frame than the window of FIG. 36.

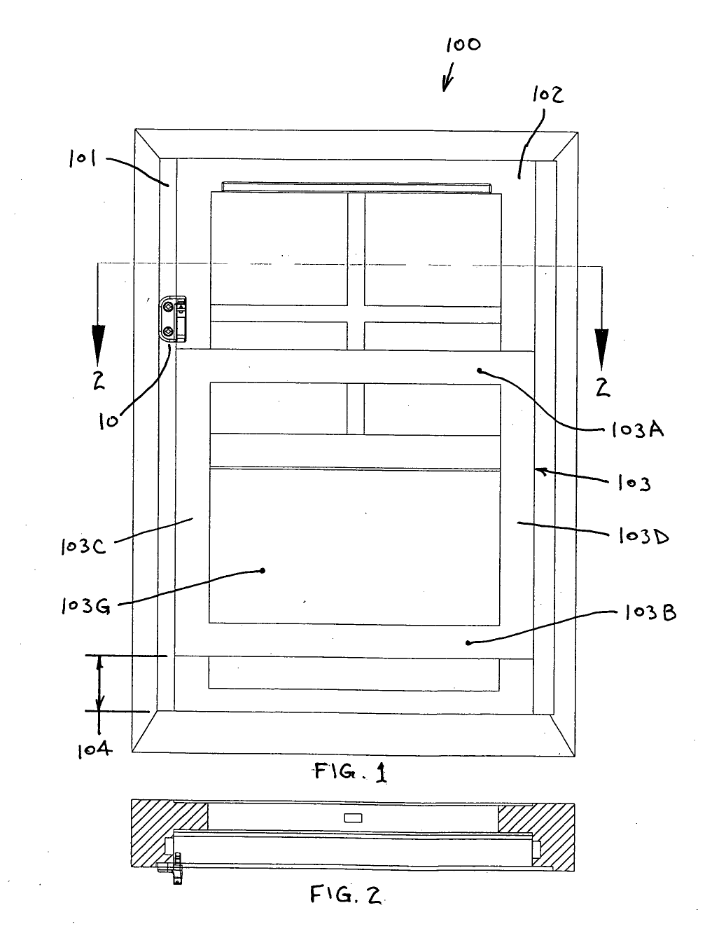

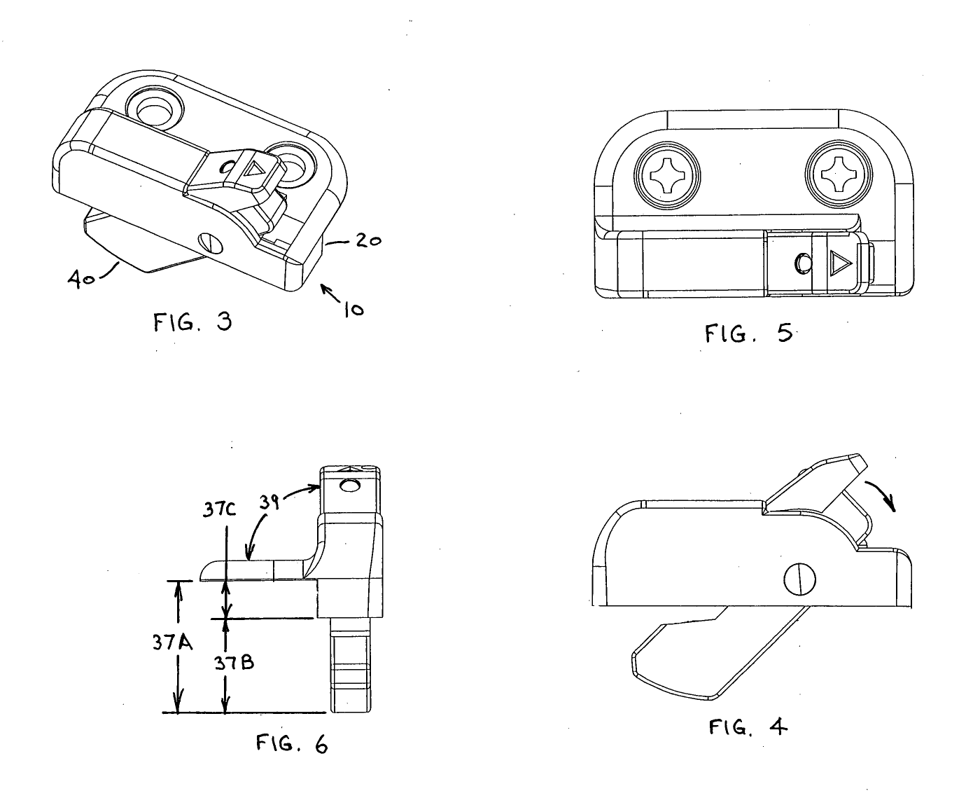

### DETAILED DESCRIPTION OF THE INVENTION

FIG. 5 shows a first embodiment of the adjustable window stop assembly 10 of the present invention, which may be practiced using the adjustable window stop assembly 10 and one or more spacer blocks (80A, 80B, etc) of the same or of varying thickness.

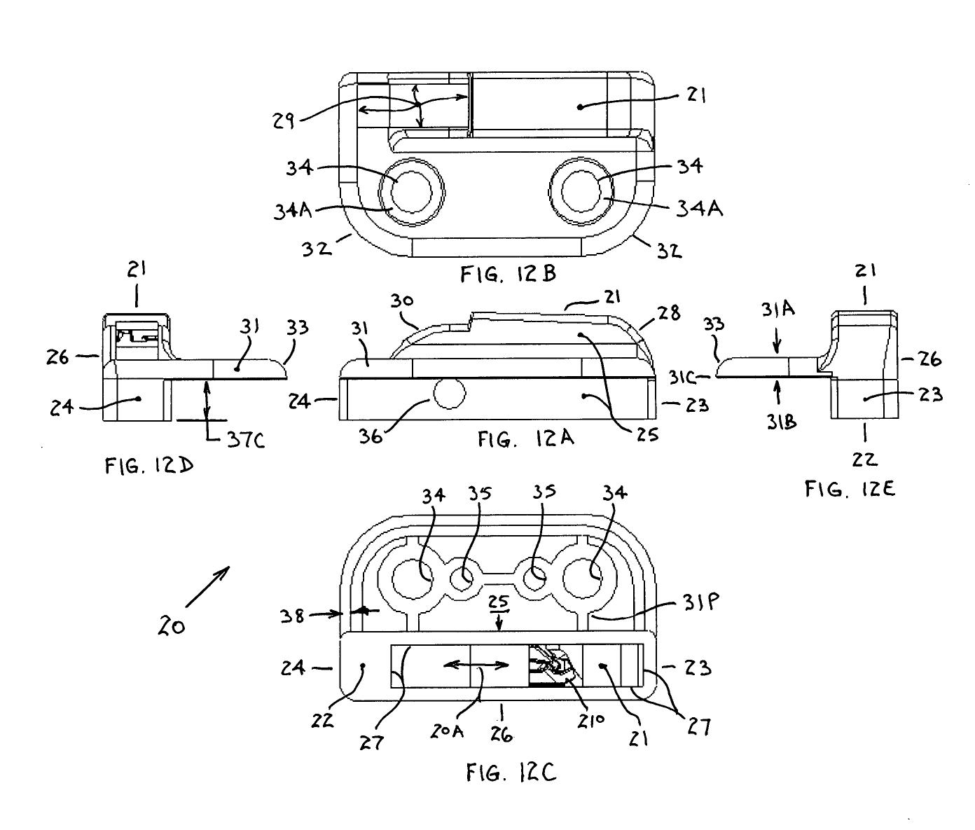

The window stop assembly 10 may include a housing 20, a tumbler 40, and a biasing member 60, as seen in FIG. 20, the operation of which is disclosed by U.S. patent application Ser. No. 12/456,347, which claims priority on U.S. Provisional Application Ser. No. 61/217,365, filed May 29, 2009, the disclosures of each being incorporated herein by reference. The housing 20 may be constructed to be of many different shapes, and need not resemble the box-like structure of the housing shown in FIGS. 12A through 12E. In fact, the housing could be formed of a single walled member and could resemble half of an egg-shape. It may be formed as one continuous piece, as with a casting or an injection molded plastic part, or it may be an assembly of several wall members that are assembled using mechanical fasteners. Using a box-like formation for the housing results in simplification of several other aspects of the design of the safety stop herein, and is therefore described in one embodiment.

The housing 20 may comprise a top wall 21, a bottom wall 22, a first end wall 23, a second end wall 24, a first (uninterrupted) side wall 25, and a second (interrupted) side wall 26, to create a cavity 20A. The second side wall 25 may have extending therefrom a mounting flange 31, which may be formed integral to the housing, or may be attached thereon using mechanical fasteners or a welding process. The mounting flange 31 may be comprised of a top surface 31A, a bottom surface 31B, and a periphery 31C that may be of a generally rectangular shape, except for a pair of outside corner radii 32. The mounting flange may have two or more mounting holes 34 running completely through the flange, from the upper surface 31A to the lower surface 31B. The holes 34 may additionally have a countersink 34A or a countersink with a recess for accommodating flush-head or pan-head fasteners. Both the top surface 31A and the bottom surface 31B may be flat. However, in an alternate embodiment, the bottom surface 31B may be sculpted to leave behind a padded area 31P in the region around holes 34, as well as a ridge of thickness 38 along the edge. The mounting flange 31 may have one or more additional holes 35 which begin at the bottom surface 31B of the mounting flange 31. The holes 35 may be full depth, or may alternatively only penetrate to a depth being between the bottom surface 31B and the upper surface 31A, so as to improve the visual appearance of the safety stop. These additional holes 35 may be used to receive posts located on the spacer blocks 80A and 80B in a friction fit, which will be discussed hereinafter.

The thickness of the mounting flange 31, as well as the housing walls 21-26, may be sized to prevent impact loads, generated from a force exerted on the sliding sash by an intruder, from easily destroying the safety stop, as an intruder may seek to gain unauthorized entry into a dwelling in that manner. The choice of material for constructing the stop may similarly serve to deter such a forced entry. The periphery 31C of the mounting flange 31 may have the upper edge broken with a radius 33, as seen in FIGS. 12D and 12E.

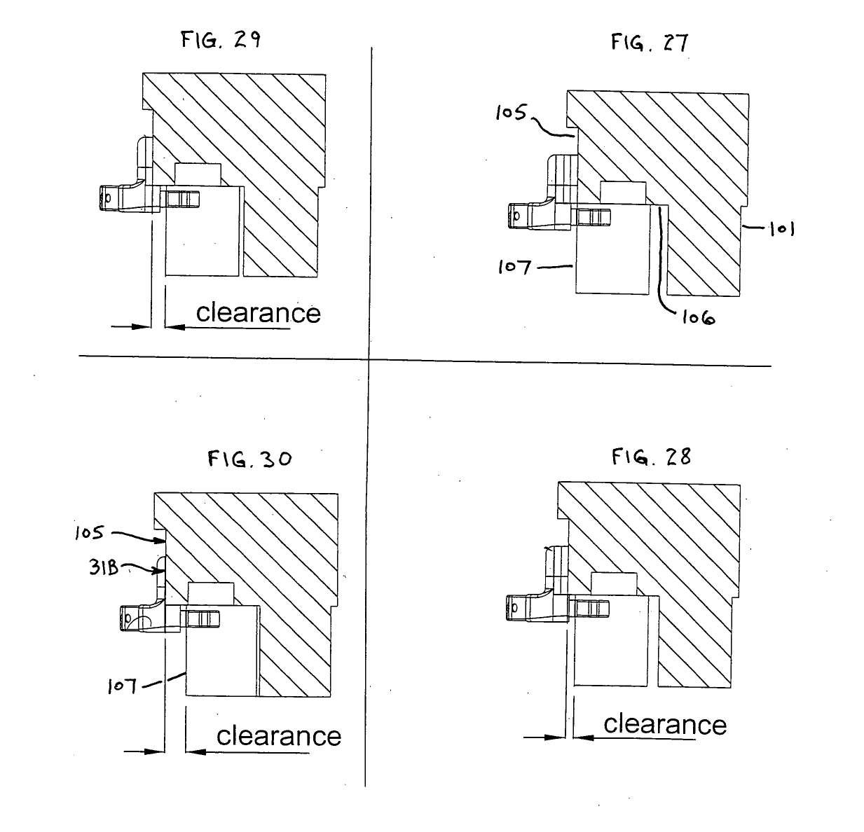

The mounting flange 31 may be positioned on the second side wall 25 so as to be located in between the top wall 21 and the bottom wall 22 of the housing 20. The mounting flange 31 may be offset from the bearing surface area 45 of the tumbler a distance 37A (FIG. 6) that may accommodate most windows. The amount of offset relates to the invention providing the capability of a functional installation on variations different configurations of windows and doors, as will be discussed hereinafter. It should be noted that the offset could be incrementally varied so as to produce a series of different stop assemblies to accommodate the different sash-to-frame depth differences discussed later (see FIGS. 27-30), but the invention may preferably be practiced according to the embodiment described herein where the spacers permit a user to install the stop on various different windows without needing to purchase a specific stop having a particular offset.

The bottom wall 22 of the housing may also be generally flat and be offset from the bearing surface area 45 a distance 37B (FIG. 6), so that the flange 31 position on side wall 25 and the housing bottom wall 22 have a corresponding relationship. Therefore, the mounting flange may also be generally parallel to the bottom wall 22, but offset therefrom by an amount 37C (FIGS. 6 and 12E). The mounting flange 31 may also protrude out from the housing side wall 25 to be at and angle 39 relative to that wall. The angle 39 may preferable be 90 degrees, but the flange may also protrude out at a non-orthogonal angle.

The housing 20 may further comprise an opening 27 in at least a portion of the bottom wall 22 to expose cavity 20A, to thereby accommodate pivotal installation therein, and subsequent pivotal motion therefrom, of the tumbler 40. The opening 27 may remove the bottom wall 22 completely between the first side wall 25 and the second side wall 26, as seen in FIG. 12C. Opening 27 may also remove the bottom wall up to the inside of wall 23, but may fall short of reaching wall 24

There may also be an opening 29 in the top wall 21 to expose cavity 20A, as seen in FIG. 12B. The top wall 21 and the first side wall 25 and second side wall 26 may be trimmed back to have a periphery 30, which may enable insertion of the tumbler 40 through the opening 29, for its pivotal mounting in the housing cavity 20A (FIG. 4). The pivotal mounting may be accommodated by a pair of in-line holes 36 in the first and second side walls 25 and 26, to receive a pair of integral pins on the tumbler 40. In an alternate embodiment, there may be pins on the housing 20 to be received by an orifice in the tumbler 40 (not shown), or there may be a separate pin that is received by holes in both the housing walls and the tumbler. In addition, the housing 20 may also have a curved transition wall 28 between top wall 21 and first end wall 23 (FIG. 12A).

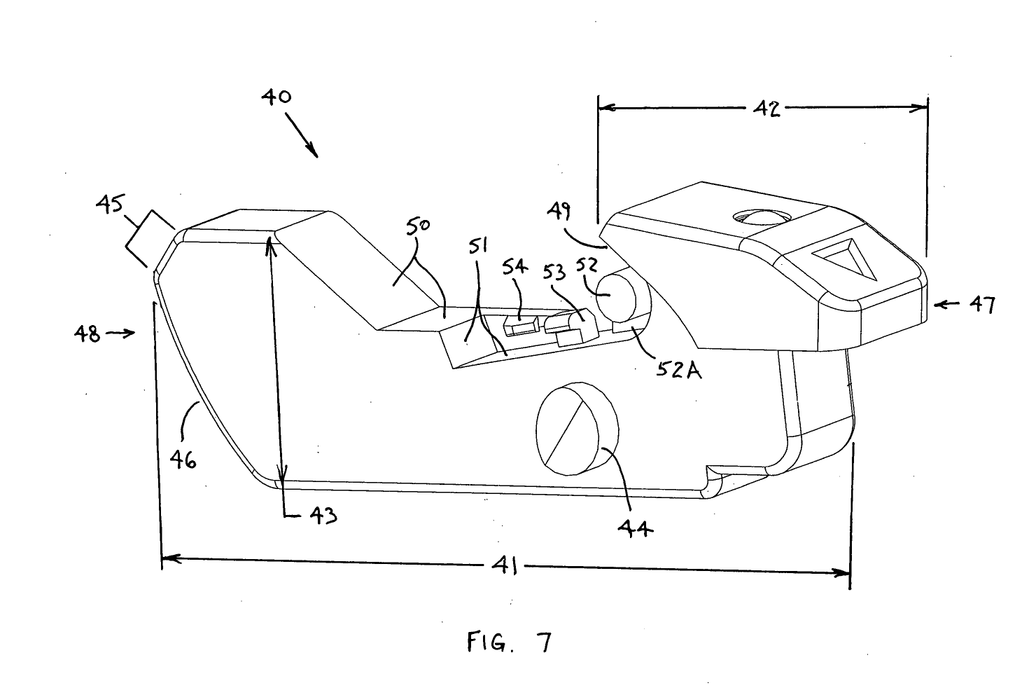

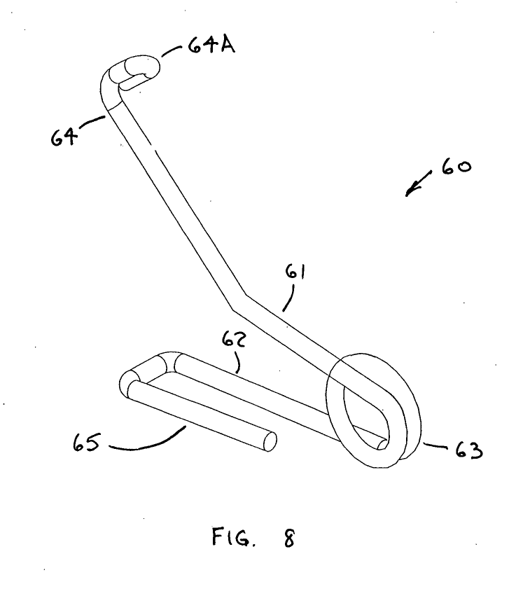

Tumbler 40, as seen in detail in FIG. 7, may be comprised of a body portion 41, and a button portion 42, and may be considered to have a first end 47, where the button may be located, and a second end 48. The body portion 41 may be comprised of an elongated, generally rectangular section 43 that is interrupted by several features. The elongated body portion 41 may be so shaped to fit within the cavity 20A of housing 20, that may be formed by the generally orthogonal housing walls 21-26. The body 41 may include a pair of cylindrical pins 44 protruding outward from each side of the body. The periphery of body 41 may also include a curved portion 45, which may be used to help deflect the tumbler, when it is not in the safe (first) position, as will be discussed hereinafter in the description of the installation of the safety stop assembly 10. The body 41 may also include a bearing surface area 45, which may be used when the safety stop assembly is in the safe position, to inhibit travel of the sliding sash by having the to rail 103A of the sash member 103 contact the bearing area 45.

The periphery of the body 41 may also be interrupted by a first notch 50, and also by a secondary notch 51, which may not cut completely across the entire width of the tumbler body from one side to the other. Both notches may nonetheless leave behind several protruding features. These protruding features include a cantilevered post 52, an L-shaped protrusion 53, and a straight protrusion 54, all of which may be used to secure the second end 65 of biasing member 60 to the tumbler 40.

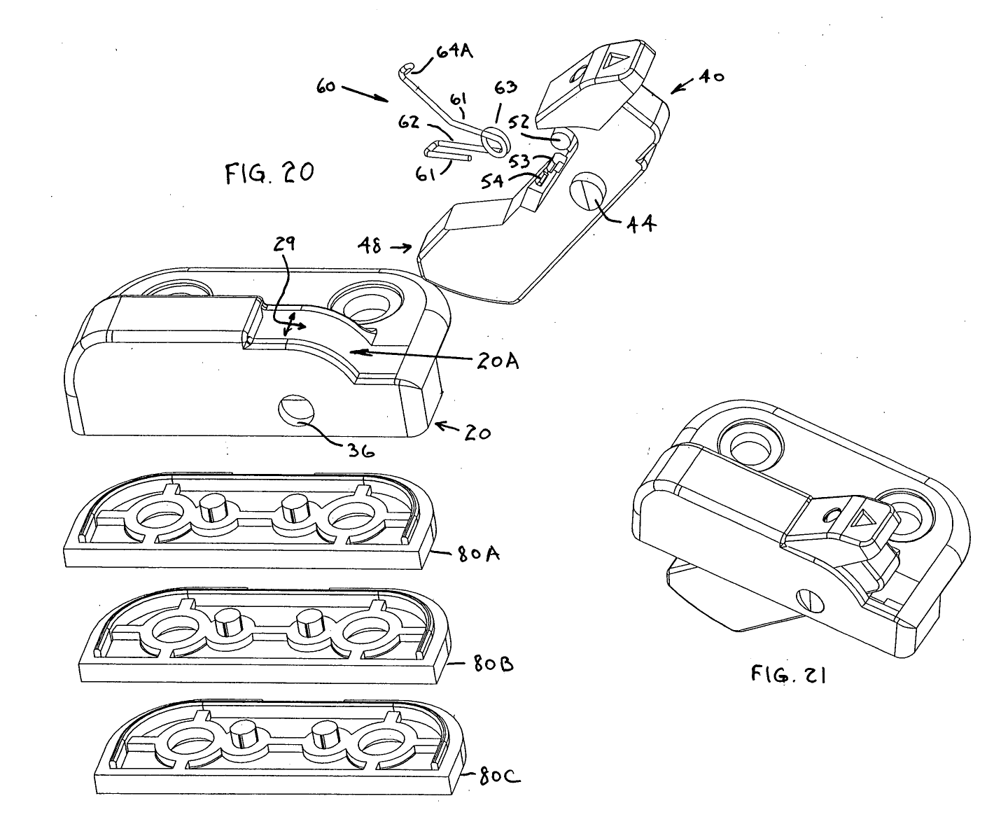

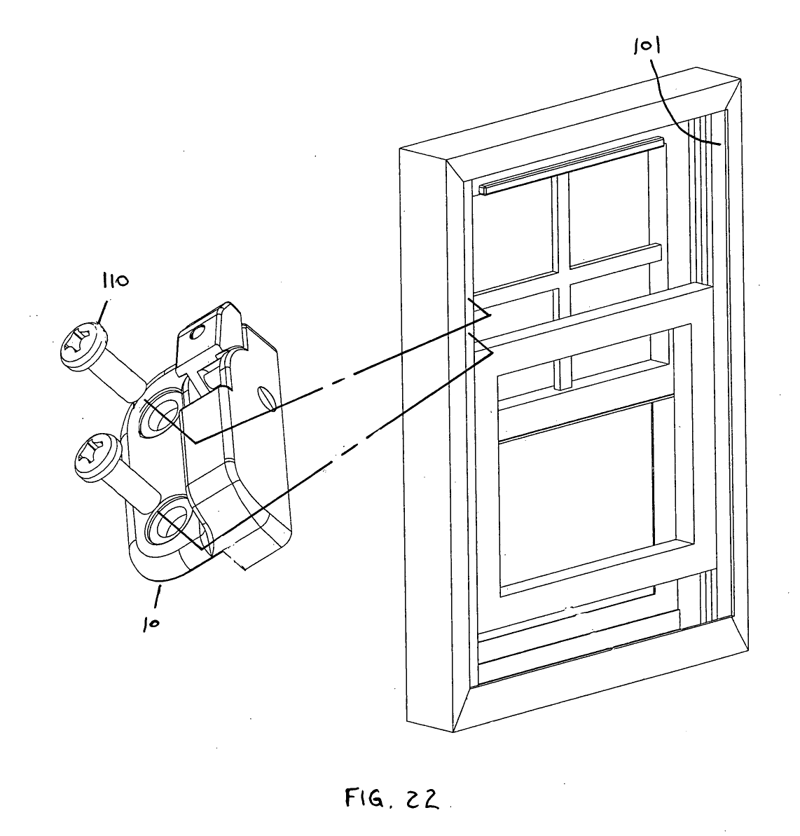

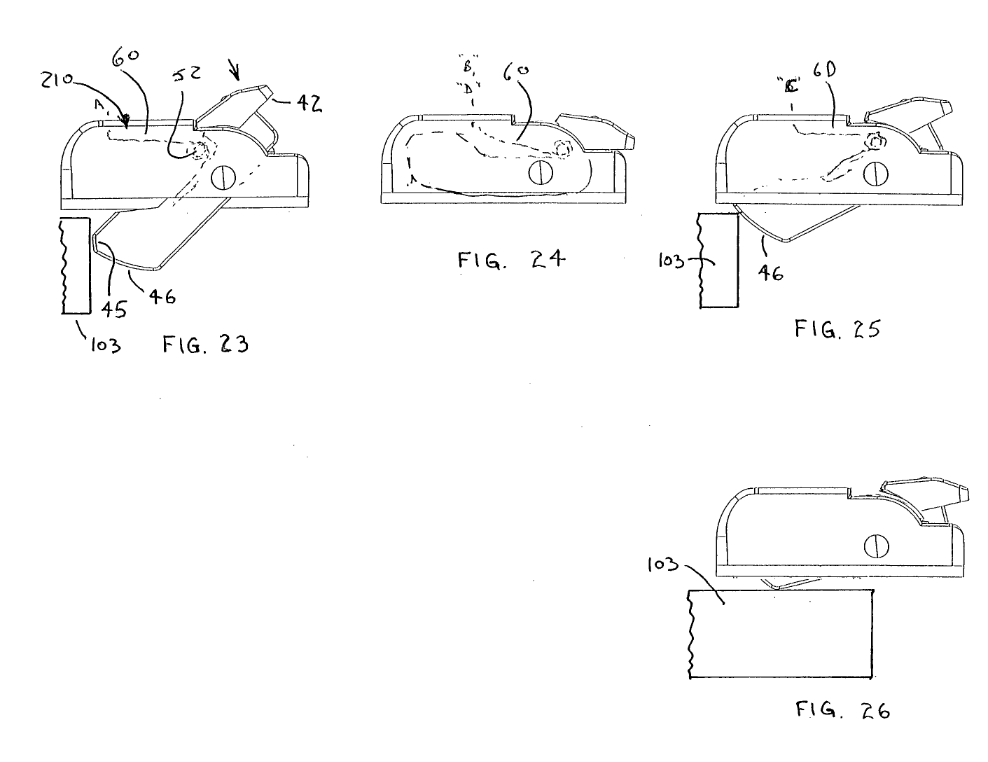

The integral button portion 42 may be of any shape and size that may conveniently receive pressure from a user's finger to toggle the tumbler from a safe (first) position to a non-safe (second) position, and for toggling the tumbler from the second position back to the first position. The tumbler positions achieved by the current invention are shown in succession in FIGS. 23-26. The safe (first) position is shown in FIG. 23. Thereafter, application of a generally downward force to the button portion 42, results in the tumbler being completely or nearly completely disposed within the cavity 20A of housing 20, in the retracted position as seen in FIG. 24. The tumbler will temporarily occupy the retracted position, until the force is removed from the button portion 42, after which the biasing member 60 will bias the tumbler to be in the non-safe (or second) position, as seen in FIG. 25. When in the non-safe position, the sliding sash member 103 of the door or window may strike the curved surface 46 of the tumbler, and thereby deflect it out of the way, with the tumbler then occupying an intermediate retracted position, as seen in FIG. 26. The intermediate retracted position could be any position between the full retracted position of FIG. 24 and the non-safe position of FIG. 25. However, in general, the intermediate retracted position may be a position in which the second end of the tumbler is only protruding out from the housing 20 a slight amount, which may be roughly equal to the clearance between the sliding member and the housing bottom wall 22 (see FIG. 26). In a preferred embodiment, the integral button portion 42 may have a curved surface 49 (FIG. 7) that mirrors the curved surface 30 of the housing 20 (see FIG. 12A), as the button portion may be proximate thereto throughout the various positions of the tumbler (FIGS. 23-26).

The biasing member 60 may comprise many different embodiments, and may alternatively be a compression spring, a tension spring, a leaf spring, or a torsion spring, etc. In a preferred embodiment, the biasing member 60 may comprise the torsion spring illustrated in the perspective view of FIG. 8. The biasing member 60 may be a helical torsion spring having a first arm 61 and a second arm 62, being connected by one or more helical turns 63 that may create a torsional restoring force, when the arms 61 and 62 are moved apart from a rest position into a deflected position. In general, the helical turns (or coil) may be subjected to twisting about the axis of the coil by sideways forces (bending moments) applied to its ends—the arms, twisting the coil tighter. The biasing member, when constructed as a helical torsion spring, may be formed of metal rod or wire.

The second arm 62 may transition to a pair of bends that terminate in a second end 65. With the turns 63 being mounted upon the post 52 of tumbler 40 (FIG. 20), the second arm 62 and second end 65 may be fixed within the protruding features of tumbler 40. The second arm 62 may be constrained between the flat side of the L-shaped protrusion 53 and both the straight protrusion 54 and lower portion 52A of the post 52. The lower portion 52A may extend upward from notch 51, and may be wherefrom the post 52 is cantilevered. The second leg 65 may be deflected outward to then be released so as to be trapped within the “L” portion of the L-shaped protrusion 53.

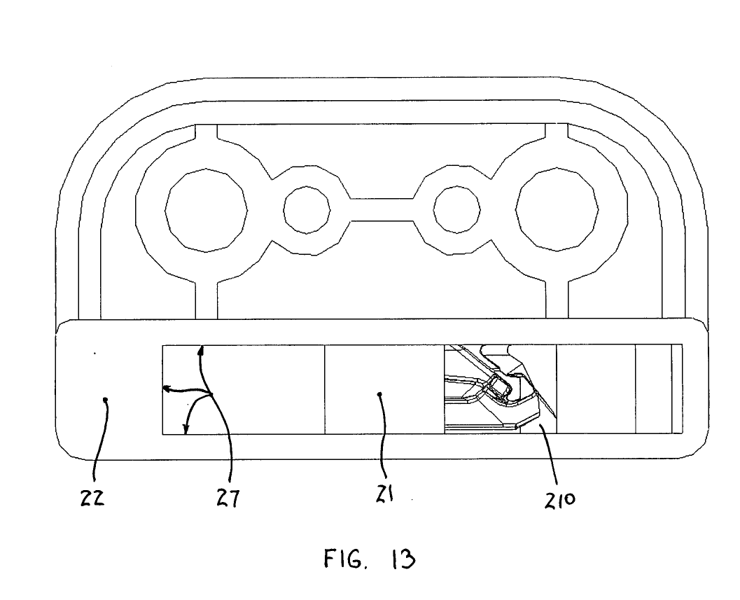

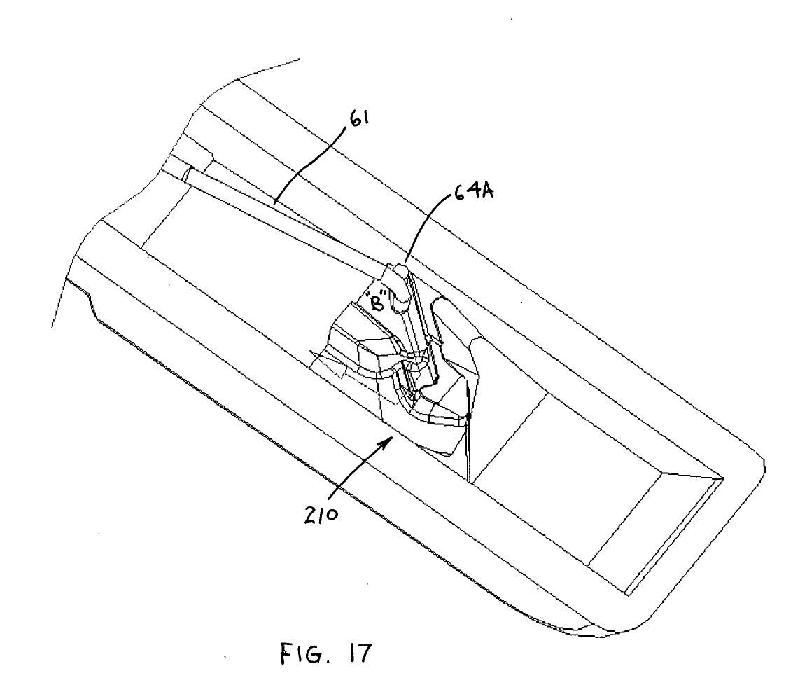

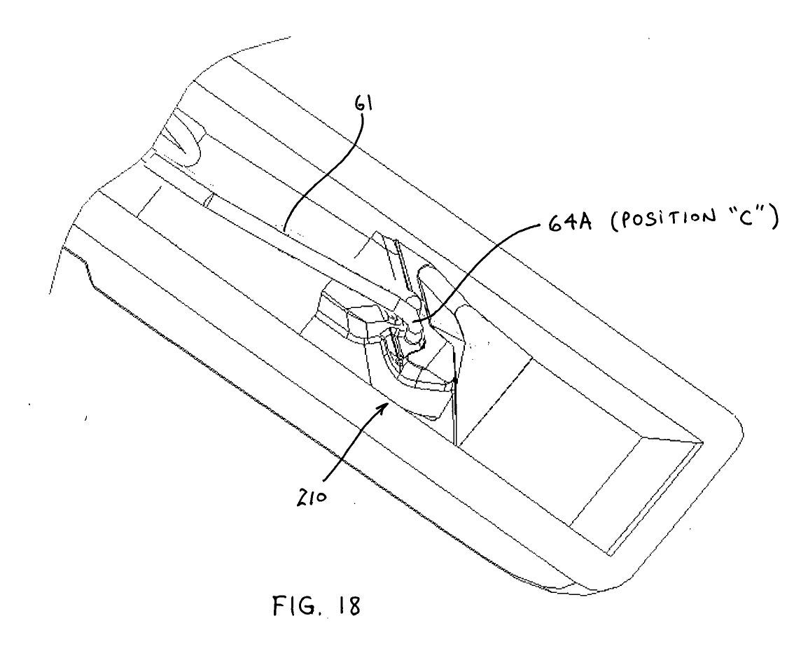

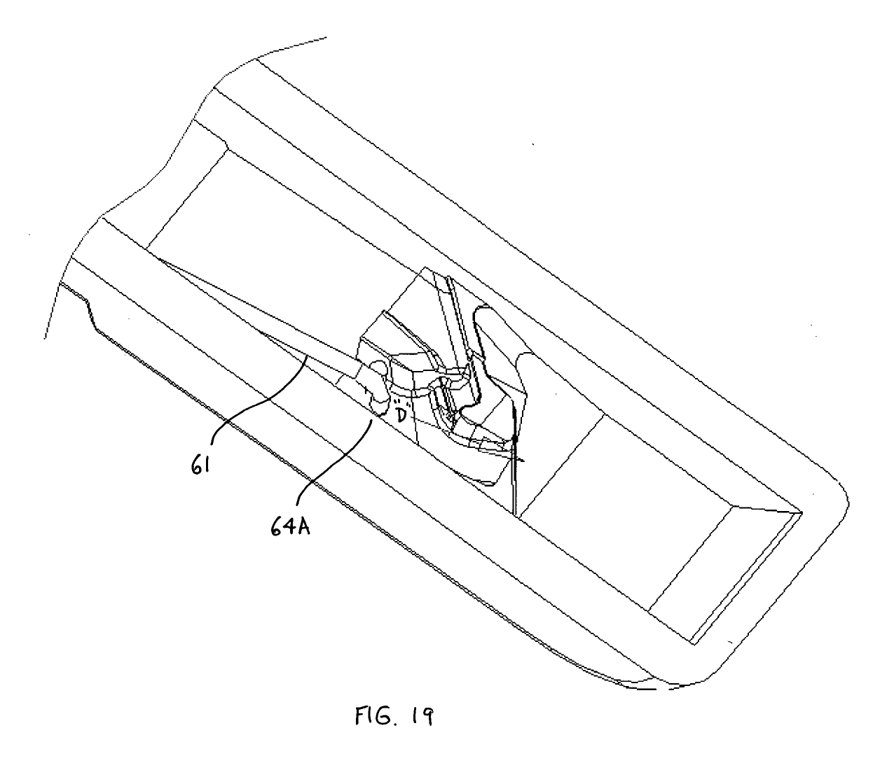

The first arm 61 may have a slight kink, as seen in FIG. 8, and then may transition into a first end 64, which may include a post 64A. The post 64A may be just the wire or rod of the torsion spring terminating to have a rounded (spherical) end, or it may alternatively have a 180 degree bend to produce a rounded edge, either of which will be referred to hereinafter as “the post.” The post 64A may serve to interact with contoured features 210 on the underside of wall 21 of housing 20 (FIGS. 13-19), to maintain the tumbler in the non-safe position, once the tumbler has been installed into the cavity 20A.

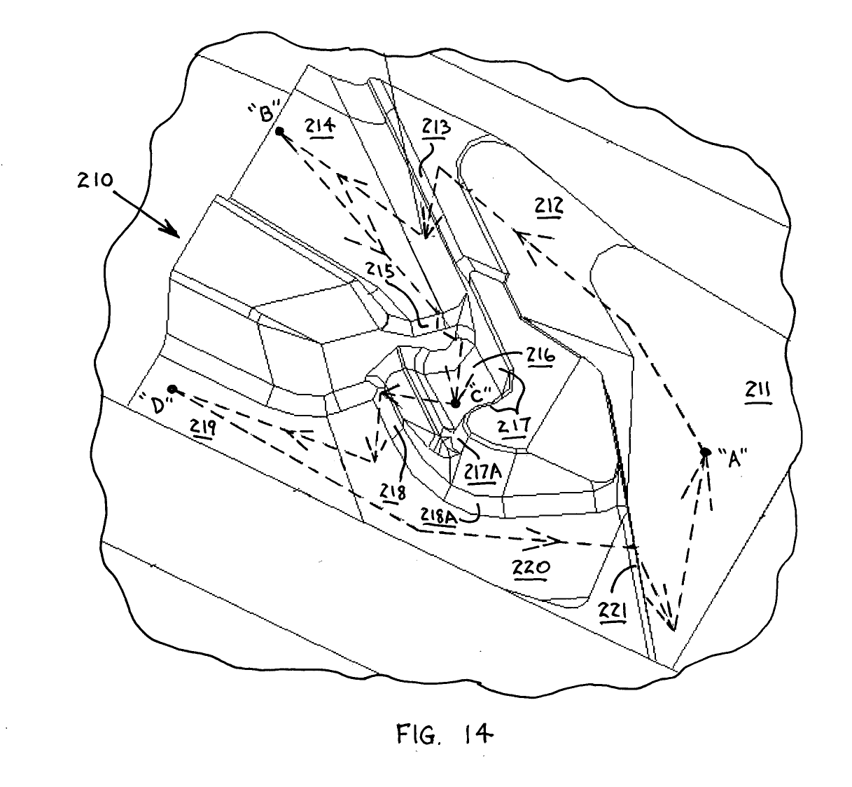

Assemblage of the housing 20, tumbler 40, and biasing member 60 into the adjustable window stop assembly 10, may be seen through the exploded view of FIG. 20. The biasing member 60 may be installed onto the tumbler 40 features as previously described. By next depressing the first arm 61 relative to the tumbler, to counter the torsion force created by the coils 63, the second end 48 of the tumbler 40 may be inserted into the cavity 20A through the opening 29 of housing 20. The pins 44 on opposite sides of the tumbler body may received by the orifices 36 of the first and second side walls 25 and 26 of housing 20, to establish pivotal mounting of the tumbler within the housing, and also leaving a portion of the tumbler second end 48 to protrude out through opening 27 of bottom wall 22 of housing 20. Once the tumbler is pivotally mounted within the housing 20, the force used to depress the first arm 61 of the biasing member 60 relative to the tumbler 40 may then be released, and the post 64A of the biasing member 60 will contact the contoured features 210 of the housing 20. That contact is seen in FIGS. 14-19.

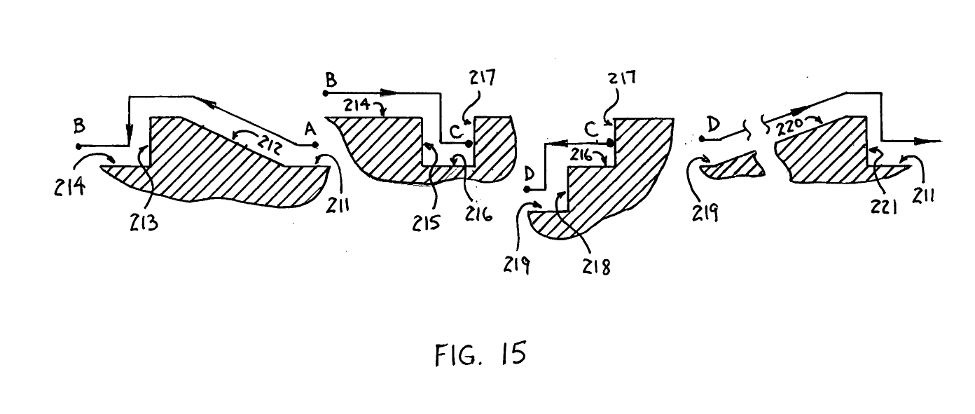

FIG. 14 illustrates, in detail, the contour features 210 of the underside of the wall 21 of housing 20, and shows thereon the positions that the post 64A of the biasing member 60 may occupy. There movement of the post 64A is shown upon the contour features 210 in FIG. 14, and also is shown schematically in FIG. 15 to aid the reader in understanding the operation of the tumbler. When the tumbler is in the safe position (FIG. 23), the post 64A of the tumbler occupies the position “A” of FIG. 14, and rests upon surface 211. As a user depresses the button 42 of the tumbler to move the tumbler from the safe position to the retracted position (FIG. 23 to FIG. 24), the post 64A in FIG. 14 will move from position “A” to position “B.” In doing so, the post 64A may move from surface 211 to contact an inclined surface 212, and then drop along a vertical face 213, to then continue along a generally flat surface 214 until reaching position “B.” Once the user releases the force from button 42 of the tumbler, the tumbler is biasing by biasing member 60 into the non-safe position (FIG. 25). Movement of the post 64A, after the user releases that force, is from position “B” to position “C.” In moving from position “B” to position “C,” the post 64A may move from the generally flat surface 214, to drop along a vertical face 215 and traverse along surface 216, where the post 64A may be nested against a curved vertical face 217. It should be pointed out that the use herein of the adjective “vertical” is to be loosely interpreted as it is being used to aid the reader in understanding the described contoured features 210 of the housing 20. Those faces, in fact, need not be “vertical” relative to the housing wall 21 or orthogonal thereto, and need only to protrude outward from either the flat or inclined surfaces to guide the travel of the post 64A. However, for simplicity in further describing the invention, the term vertical will still be used herein.

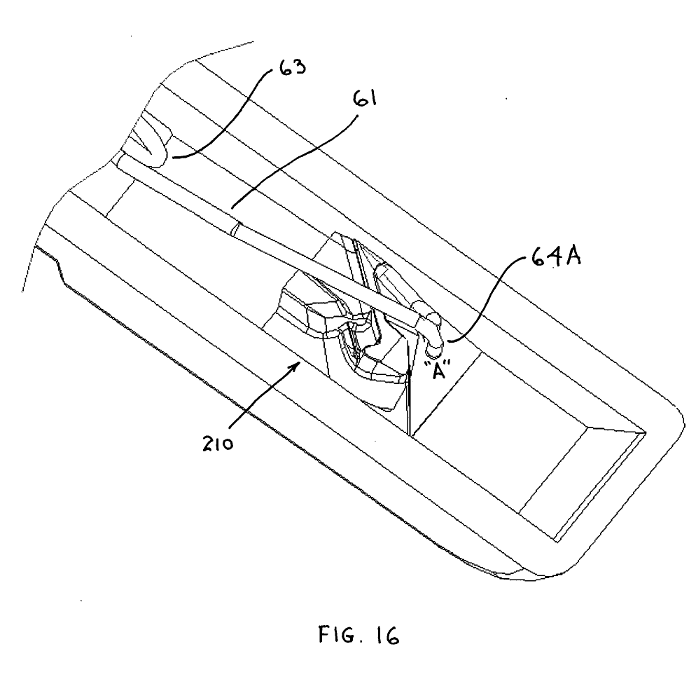

Biasing by the biasing member 60 will seek to deflect the tumbler 40 from the non-safe to the safe position, but is prevented from doing so by the vertical face 217 serving to restrain the movement of post 64A of the biasing member, which inhibits outward rotation of the tumbler. This rotationally restrictive relationship may be understood by looking at the positions of post 64A (A, B & D, and C) relative to the profile views of housing wall 21 in the FIGS. 23-25. Also, the post 64A is shown occupying positions A, B, C, and D, sequentially, in FIGS. 16-19.

Movement of the tumbler from the non-safe to the safe position may occur by the user again applying a force to button 42, which causes the tumbler to again move into a retracted position and with the post 64A respectively moving from position “C” to occupy position “D.” In moving from position “B” to position “C,” the post may move along surface 216, drop along a vertical face 218, then traverse from an inclined surface 220 to a generally flat surface 219. Once the user releases that force from button 42 of the tumbler 40, the tumbler is biased by biasing member 60 into the safe position (FIG. 23). Movement of the post 64A, after the user releases that force, is from position “D” to position “A.” In moving from position “D” to position “A,” the post may move along generally flat surface 219, then up the inclined surface 220 and down a vertical face 221, and then traverse along surface 211 until reaching position “A.” It should be pointed out that the direction of movement of the post 64A is aided by those vertical faces, which serve to prevent erroneous movement. For example, for movement of the post 64A from position “D” to position “A,” the post is prevented from inadvertently returning to “C” by the vertical face 218, which curves around at curved vertical face 218A, and thereby forces the post 64A to traverse along surface 220 and towards position “A.” Movement between each of the other positions—A to B, B to C, and C to D—is similarly accomplished by vertical faces 221, 213, and 215. The incline surfaces serve in combination with the vertical faces to facilitate construction of a continuous series of contours to permit the described motion of the post 64A.

It may now be seen by looking at FIGS. 14 and 25, that the movement from position C towards position D may be arranged so that the vertical face 217 has a rounded vertical end 217A and that vertical 218 is very quickly encountered after the post 64A has moved from position “C.” This would provide an arrangement where, in looking at FIG. 25, it may be seen that slight deflection by the sash 103 of the tumbler 40 will cause the post 64A to slip around the rounded vertical end 217A and down the vertical face 218, in proximity to curved vertical face 218A, to then be biased to position “A” without occupying position D. This may be advantageous in an embodiment where the safety stop will tend to always be in the safe position, because even where the user has toggled the tumbler to the un-safe position to open the window all the way, once the window strikes the tumbler, it will be released from position “C” as just described, and when the sash window has been return to the closed (or near closed) position, the safety stop will then automatically biased to the tumbler to the safe position—with the stop being in position “A.” If vertical face 117 and vertical face 218 extend further in the direction towards position “D,” the ability to have the window automatically trip the tumbler to bias back to the safe position may be prevented, and would thus require the user to manually choose to do so. This arrangement may also be a desirable feature for an alternative safety stop.

Similarly, it may be seen that complete movement of the post 64A into position “B,” wherein the tumbler is fully retracted within the housing, is not necessary, as the post need only move beyond the vertical face 213 to ensure that it will maneuver into position “C,” once the force is removed from button 42. However, vertical face 213 may be moved so as to be proximate to position “B,” which would necessitate that a fully retracted or near-fully retracted tumbler position would be reached before ensuring that the post would be force to engage with vertical face 217 at position “C.”

One embodiment of the spacer blocks, 80A, 80B, etc, is shown in FIGS. 9-11. The spacer blocks 80A and 80B may be identical, except for possible differences in thickness of the spacers. For the sake of commonality, only one thickness of spacer might be used, and being a very small thickness, wherein multiple spacers could be used as needed, however, the varying thickness spacers may be more practical. The spacers will be discussed generically in terms of spacer 80A, but the discussion may apply to other spacers, 80B, 80C, etc, as well, except for the aforementioned thickness differences.

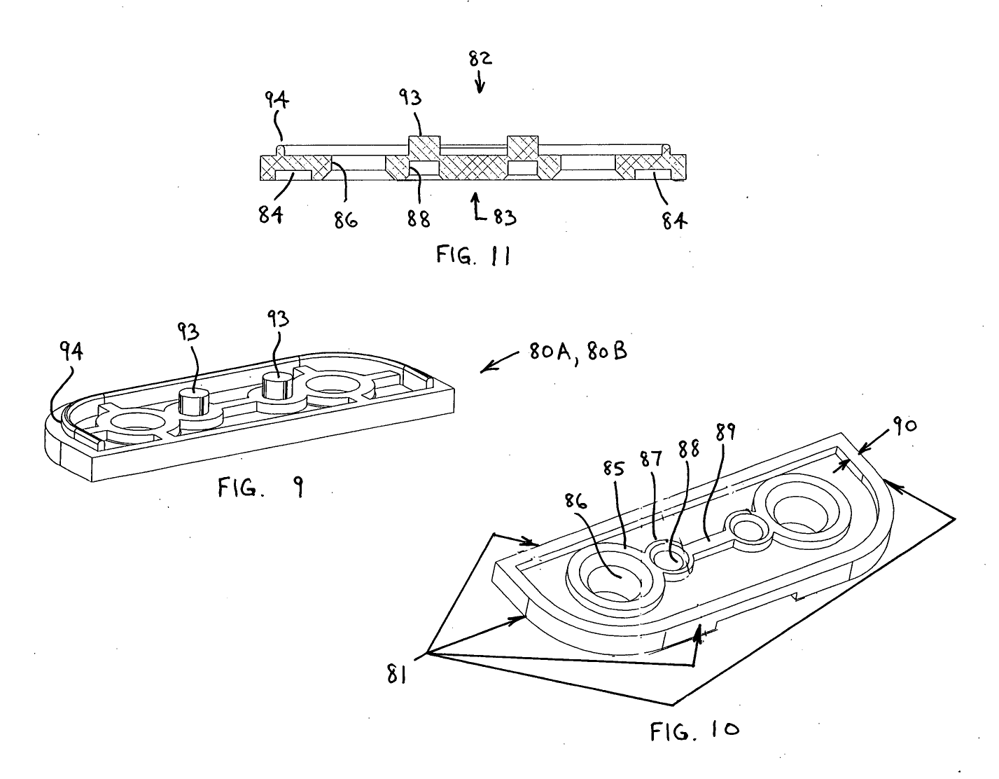

The spacer 80A may have a periphery 81 that matches the periphery of the mounting flange 31 of housing 20. Spacer 80A may also have a top 82 and a bottom 83. The bottom 83, as seen in FIGS. 10 and 11, may have a sculpted cavity 84, leaving behind a ridge of thickness 90, and a boss 85 surrounding a pair of orifices 86 that match the mounting orifices in the mounting flange 31 of the housing 20 (for receiving safety stop mounting fasteners), and a boss 87 around a second pair of smaller orifices 88. The smaller orifices 88 in the spacer, like the orifices 35 in the mounting flange 31 of housing 20, may be full depth, or may be depth limited as seen in FIG. 11. The boss 87 about each orifice 88 may be connected by a stiffener 89.

The smaller orifices 88 of the bottom 83 may be for receiving the posts 93 protruding up from the top surface, which would occur where multiple spacers (80A and 80B . . . ) are used. The posts 93 would be received, for the first spacer utilized with the stop assembly 10, by the orifices 35 in the bottom surface 31B of mounting flange 31. They may simply be nested therein, or they may be received therein using a friction fit or using a detent where the spacer would have to snap into place on the mounting flange (or other spacers when more than one spacer is used). The top surface 82 may also have an upward protruding lip 94 that spans at least part of the periphery 81, and which may be received by the ridge of thickness 38 in the bottom surface 31B of the mounting flange 31 of the housing 20, or alternately received by the ridge of thickness 90 in the bottom of other spacers, if used.

The adjustable safety stop assembly 10 may be installed on a window while the window is being assembled by a window manufacturer, or alternatively, may be installed after the window has been assembly but prior to its installation in a building. Additionally, it is also possible to install the safety stop 10 on a sash window or door that is already in service in a building, where the assembly would be supplied as an after-market stop, for use on sash members of a window/door product that did not originally incorporate a safety lock into the design of the window or door. Furthermore, after-market safety stop herein may also be installed on a window or door already in service in a building, where the window/door already had a safety stop integrally assembled into the window/door, but where the person using the window prefers to have the window stop at alternative or additional sash travel-limited safety locations. Generally, such pre-installed stops provide generous travel for the sash, but not being travel that is great enough to allow entry through the window by a burglar or other intruder. A home owner may prefer to add safety stops to that window to limit the travel to only about one or two inches, possibly to prevent a small pet from escaping, and might feel that the window only being opened that small amount would provide sufficient ventilation into the room. Also, the home owner may wish to add another safety stop to permit the window to open a little further for increased ventilation, but still not be opened enough to allow a small child to accidentally egress out of the open window. There may be many reasons for adding one or more additional safety stops to a newer window that already has an integral stop.

FIG. 22 shows a pair of screws 110 that may be used to mount the after market safety stop 10 to the master frame 101 of single hung or double hung sash window or door. FIGS. 34-37 illustrate the use of multiple spacers or no spacers, in cross-sectional views of different window configurations which have various differences in height between the sash 103 and master frame 101.

As seen throughout these views, installation of the safety stop assembly 10 may be with the bottom surface 31B of the mounting flange 31 contacting the inward facing side 105 of the master frame 101, with the tumbler second end 48 being adjacent to a side surface 106 of the master frame 101 (FIG. 27), and with the tumbler bearing surface at the second end being proximate to the top rail of the lower sliding sash member (FIG. 23). The top rail of the lower member may best be referred to herein for safety locking, as an inner rail 103A of the sliding sash member.

The offset amount in locating the mounting flange 31 on the side wall 25 of housing 20 relative to the bottom wall 22 may determine the thickness of the spacers used, along with the depth difference between the inward facing surface 105 of the master frame and the inward facing surface 107 of the sash 103, for a given safety stop assembly 10. As may be seen from FIGS. 27-30, a formula for the thickness of the total stack of spacer blocks may be approximately equal to that mounting flange offset minus the measured depth (or height) difference between the window and master frame, plus a small amount for clearance. As seen in FIG. 30, where the depth difference between the inward facing side of the master frame 105 and inward facing side 107 of the sash member 103 is equal to or slightly greater than the offset amount of the mounting flange, no spacer is required. As the depth difference is reduced in going from FIG. 27 through FIG. 30, the total thickness of the spacers 80A, 80B, . . . , that are used must increase. The maximum thickness would be required (FIG. 27) when the inward facing side of the master frame 105 and inward facing side 107 of the sash member 103 are flush (zero depth difference), and which would require a spacer total thickness approximately equal to the offset of the mounting flange from the bottom wall 22 of housing 20, plus a small added amount to provide clearance between the bottom wall 22 with the sash member 103, to thereby prevent its obstruction.

The examples and descriptions provided merely illustrate a preferred embodiment of the present invention. Those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the preferred embodiment without departing from the spirit of this invention.

We claim:

1. A stop, for attachment to a frame of a sliding member installed in a structure, said stop being capable of limiting sash travel between a closed position and a partially opened position, said partially opened position being a sash position between said closed sash position and a full-open sash position, said stop comprising;
a housing, said housing comprising a cavity and at least one opening in a top end of said housing interconnecting with said cavity, and at least one opening in a bottom end of said housing interconnecting with said cavity;
a tumbler, said tumbler comprising a first end and a second end; said tumbler being pivotally mounted in said housing cavity, said tumbler pivoting at a point between said first end and said second end of said tumbler;
a biasing member, said biasing member biasing said second end of said tumbler to pivot outward from said housing; said tumbler being capable of toggling between a first position and a second position; said tumbler second end comprising a bearing surface, and wherein when said tumbler is in said first position, said bearing surface limits movement of said sash between said closed position and said partially opened position; said tumbler permitting sash movement between said closed position and said full-open position when in said second position; a portion of said biasing member selectively contacting a portion of said housing to limit said outward pivotal travel of said tumbler to be at said first position; and
a mounting flange, said mounting flange protruding outward from said housing and being offset from said bearing surface; said mounting flange comprising a top surface and a bottom surface; and said mounting flange comprising a means for securing said stop to a surface.

2. The stop of claim 1, wherein said portion of said housing being contacted by said biasing member to limit said outward pivotal travel of said tumbler comprises a contoured feature on said housing.

3. The stop of claim 2, wherein said tumbler toggles between said first position and said second position by a force applied at said tumbler first end.

4. The stop of claim 3, wherein said force applied at said tumbler first end causes said tumbler to toggle from said first position to a retracted position, said first position being a fully extended position, said retracted position being a position wherein at least a portion of said tumbler second end is retained within said housing cavity; and wherein releasing said force from said tumbler first end permits said tumbler to be biased from said retracted position to said second position.

5. The stop of claim 4, wherein when said tumbler is in said second position, said at least a portion of said tumbler second end protruding out from said housing permits movement of said sash past said tumbler by said sash contacting a curved surface of said tumbler and deflecting said tumbler into an intermediate position, said intermediate position being a position between said second position and said retracted position, said tumbler occupying said intermediate position until said sliding sash moves in said frame to a position between said partially opened position and said closed position.

6. The stop of claim 5, wherein said second position further comprises a position wherein at least a portion of said tumbler second end protrudes out from said housing.

7. The stop of claim 6, wherein when said sash contacts said curved surface of said tumbler to deflect said tumbler into said intermediate position, and when said sash has moved in said frame to said position between said partially opened position and said closed position, said tumbler is thereby permitted to be biased back to said second position.

8. The stop of claim 6, wherein when said sash contacts said curved surface of said tumbler to deflect said tumbler into said intermediate position, and when said sash has moved in said frame to said position between said partially opened position and said closed position, said portion of said biasing member selectively contacting said contoured feature of said housing no longer limits said outward pivotal travel of said tumbler, and said tumbler is biased back to said first position.

9. The stop of claim 5, wherein when said tumbler occupies said second position and another force is applied at said tumbler first end, said another force causes said stop to toggle from said second position to said retracted position, and wherein releasing said another force from said tumbler first end permits said tumbler to be biased from said retracted position to said first position.

10. The stop of claim 9, wherein said biasing member comprises a helical torsion spring, said helical torsion spring comprising a helical coil with first and second arms extending therefrom.

11. The stop of claim 10, wherein said helical coil and said first arm of said torsion spring are affixed to said tumbler, and wherein said second arm terminates in a post, said post serving to bias said tumbler relative to said housing by said selective contact with said contoured feature of said housing.

12. The stop of claim 11, wherein said selective contact of said post of said biasing member with said contoured feature of said housing comprises guided post movement from a position “A” to a position “C”; said position “A” being a position at which said outward pivotal tumbler movement is limited to said first position of said tumbler by a portion of said first end of said tumbler contacting a portion of said housing; and said position “C” being a position at which said outward pivotal tumbler movement is limited to said second tumbler position by said post nesting within a curved vertical face of said contoured feature of said housing.

13. The stop of claim 12, wherein said guided movement of said biasing member post from position “A” to position “C” comprises movement of said post up an inclined surface and over a first vertical face to a position “B”, said position “B” being a post position beyond said first vertical face and corresponding to said tumbler retracted position resulting from said user applied force; and wherein when said user applied force is removed, biasing of said tumbler causes said post to move back towards position “A” and contact said first vertical face, said first vertical face guiding movement of said post away from position “A” and down a second vertical face to be in position “C,” said first vertical face transitioning into said curved vertical face.

14. The stop of claim 13, wherein said selective contact of said post with said contoured feature of said housing comprises further guided movement, said further guided movement comprising movement from said position “C” back to said position “A”; said further guided movement from position “C” to position “A” comprising movement of said post over a third vertical face and down a second inclined surface into a position “D,” said position “D” being a post position corresponding to said tumbler retracted position resulting from said another user applied force at said tumbler first end; and wherein when said another user applied force is removed, biasing of said tumbler causes said post to move up said second inclined surface and down a fourth vertical face to be in said position “A,” said third vertical surface guiding movement of said post away from said position “C” and toward said position “A.”

15. The stop of claim 4, wherein said means for securing said stop to said frame surface comprises one or more orifices in said mounting flange, wherein each of said one or more orifices receive a fastening means for mounting said stop to said frame with said bottom surface of said mounting flange contacting said frame surface.

16. The stop of claim 15, wherein said stop further comprises an assembly, said stop assembly comprising said stop and a spacer block, said spacer block being capable of removably attaching to said mounting flange bottom surface, and having a thickness to adjust for variations in a height difference between said sliding sash and said frame for various manufacturers of said sliding member.

17. The stop of claim 16, wherein said spacer block has a top surface, a portion of said top surface being capable of removably attaching into said bottom surface of said mounting flange by either of said spacer block top surface or said mounting flange bottom surface comprising at least one post, and the other of said spacer block top surface or said mounting flange bottom surface comprising a respective orifice.

18. The stop of claim 17, wherein said post is removably received in said respective orifice by a sliding friction fit; and wherein said respective orifice is in said mounting flange and begins at said mounting flange bottom surface and runs at least part way between said bottom surface of said mounting flange and said top surface of said mounting flange.

19. The stop of claim 18, wherein said spacer block further comprises a respective orifice on a bottom surface for releasably receiving one or more posts of a second spacer block, said second spacer block being of a thickness different than said thickness of said first spacer block, said second spacer block further comprising a respective orifice on a bottom surface.

20. The stop of claim 19, wherein a plurality of additional spacer blocks comprise different thicknesses, and wherein selection of one or more spacer blocks from among said first and second and said plurality of spacer blocks permits accommodation of said variations in a height difference.

21. The stop of claim 20, wherein each of said spacer blocks comprises a periphery with a shape that matches a peripheral shape of said stop mounting flange.

22. The stop of claim 21, wherein said mounting flange protrudes out from said housing at a position between said top end and said bottom end of said housing; and wherein said mounting flange is generally parallel to said housing bottom end but offset therefrom by a certain amount.

23. The stop of claim 22, wherein a total thickness of said one or more spacer blocks is approximately equal to said certain amount of mounting flange offset minus said sash to frame height difference, plus a clearance amount.

24. The stop of claim 1, wherein mounting of said stop at said partially opened position permits said sash opening to be sufficient for accommodating ventilation but insufficient to permit entry by an intruder.

25. The stop of claim 24, wherein said housing comprises at least first and second side walls, said first and second side walls being roughly parallel to each other and being separated to create said cavity.

26. The stop of claim 25, wherein said pivotal arrangement comprises attachment of said tumbler to said housing one or more pins.

27. The stop of claim 26, wherein said tumbler comprises an integral pin protruding from each of a first side and a second side of said tumbler; and wherein said pins of said tumbler are pivotally received in a respective orifice in said first and second housing side walls.

28. The stop of claim 27, wherein said housing top end further comprises a top wall connecting at least a portion of said first and second side walls.

29. The stop of claim 28, wherein said tumbler first end further comprises a button integral to said tumbler first end, said button protruding out from said at least one opening in said housing top end, said button for receiving application of said force by a user to toggle said tumbler.

30. The stop of claim 29, wherein said mounting flange protrudes out from said housing at a position between said top end and said bottom end of said housing; and wherein said mounting flange is at a non-orthogonal angle to said first and second side walls of said housing.

31. The stop of claim 30, wherein said fastening means comprises a mechanical fastener from the group consisting of: a screw, a nut and bolt, and a rivet; and wherein said biasing member comprises a torsion spring.

32. A stop, for attachment to a frame of a sliding member, to thereon be capable of limiting sash travel between a closed position and a partially open position, said partially open position being a sash position between said closed position and an open position, said stop comprising;
a housing;
a tumbler, said tumbler comprising a first end and a second end; said tumbler being pivotally mounted in said housing; said tumbler pivoting at a point between said first end and said second end of said tumbler;
a biasing member, said biasing member biasing said tumbler second end to pivot outward from said housing; said tumbler being capable of pivoting between a first position and a second position when said tumbler first end is toggled; said tumbler second end comprising a bearing surface, and wherein when said tumbler is in said first position, said bearing surface blocks movement of said sash; and said tumbler permitting sash movement when in said second position; a portion of said biasing member selectively contacting a portion of a contoured feature of said housing to limit said outward pivotal travel of said tumbler to be at said first position; and
a mounting flange, said mounting flange extending from said housing at a position between said top end and a bottom end of said housing; said mounting flange being offset from said housing bottom end; said mounting flange comprising a means to secure said stop to a surface.

33. The stop of claim 32, wherein said tumbler of said stop toggles between said first position and said second position by a force applied at said tumbler first end.

34. The stop of claim 33, wherein said force applied at said tumbler first end causes said stop to toggle from said first position to a retracted position, said retracted position being a position wherein at least a portion of said tumbler second end is retained within said housing; and wherein releasing said force from said tumbler first end permits said tumbler to be biased from said retracted position to said second position, said second position further comprising a position wherein at least a curved surface of said tumbler second end protrudes out from said housing.

35. The stop of claim 34, wherein when said tumbler is in said second position, said at least a curved surface of said tumbler second end protruding out from said housing permits movement of said sash past said tumbler by said sash contacting said curved surface of said tumbler and overcoming said biasing to deflect said tumbler into an intermediate position, said intermediate position being a position between said second position and said retracted position, said tumbler occupying said intermediate position until said sliding sash moves in said frame to a position between said partially opened position and said closed position, thereby permitting said tumbler to be biased back to said second position.

36. The stop of claim 35, wherein when said tumbler is in said second position and said force is applied at said tumbler first end, said force causes said stop to toggle from said second position to said retracted position, and wherein releasing said force from said tumbler first end permits said tumbler to be biased from said retracted position to said first position.

37. The stop of claim 36, wherein said stop further comprises a spacer block, said spacer block being capable of removably attaching to said mounting flange bottom surface, said spacer block having a thickness to adjust for a height difference between said sliding sash and said frame to thereby permit said sash movement with said tumbler in said second position and inhibit said sash movement with said tumbler in said first position.

38. The stop of claim 37, wherein said spacer block has a top surface and at least a portion of said top surface removably attaches to said bottom surface of said mounting flange by either of said spacer block or said mounting flange bottom surface comprising at least one post, and the other of said spacer block or said mounting flange bottom surface comprising a respective orifice, said post being releasably received in said respective orifice by a sliding friction fit.

39. The stop of claim 38, wherein said spacer block further comprises a respective orifice on a bottom surface for releasably receiving one or more posts of a second spacer block, said second spacer block being of a thickness different than said thickness of said first spacer block, said second spacer block further comprising respective orifices on a bottom surface; and wherein at least one additional spacer block comprising a different thickness may thereby be attached, and wherein said thickness of said first spacer block and said thickness of said second spacer block permits accommodation of said sash to frame height difference.

40. An after-market stop, for attachment to a sash window or door, said sash window/door assembly being already manufactured and used in service, said after-market stop being thereon capable of limiting sash travel between a closed position and a partially open position, said partially open position being a sash position between said closed sash position and a full-open sash position, said stop comprising;
a housing, said housing comprising one or more walls to create a cavity therein, said housing walls forming a top end and a bottom end;
a tumbler, said tumbler comprising a first end and a second end; said tumbler being pivotally mounted in said housing cavity, said tumbler pivoting at a point between said first end and said second end of said tumbler;
a biasing member, said biasing member biasing said second end of said tumbler to pivot outward from said housing; said tumbler being capable of bi-directional toggling between a first tumbler position and a second tumbler position, when said tumbler first end is actuated; said tumbler second end comprising a bearing surface, and wherein when said tumbler is in said first position, said bearing surface limits movement of said sash between said closed position and said partially open position; said tumbler permitting sash movement between said closed position and said full-open position when in said second position; a portion of said biasing member selectively contacting a portion of a contoured feature of said housing to limit said outward pivotal travel of said tumbler to be at said first position; and
a mounting flange, said mounting flange comprising a top surface and a bottom surface; said mounting flange protruding outward from said housing, and protruding out at a position between said top end and said bottom end of said housing; said mounting flange being generally parallel to said housing bottom end and offset therefrom by a certain amount; and said mounting flange comprising two or more orifices.

41. The after-market stop of claim 40, wherein said movement from said first position to said second position and from said second position to said first position each occur by said tumbler initially moving into an third position, said third position being a retracted position wherein at least a portion of said tumbler second end is within said housing.

42. The after-market stop of claim 41, wherein said biasing member comprises a helical torsion spring, said helical torsion spring comprising a helical coil with first and second arms extending therefrom.

43. The after-market stop of claim 42, wherein said helical coil and said first arm of said torsion spring are affixed to said tumbler, and wherein said second arm terminates in a post, said post serving to bias said tumbler relative to said housing by said selective contact with said contoured feature of said housing.

44. The after-market stop of claim 43, wherein said selective contact of said post of said biasing member with said contoured feature of said housing comprises guided post movement from a position “A” to a position “C”; said position “A” being a position at which said outward pivotal tumbler movement is limited to said first position of said tumbler by a portion of said first end of said tumbler contacting a portion of said housing; and said position “C” being a position at which said outward pivotal tumbler movement is limited to said second tumbler position by said post nesting within a curved vertical face of said contoured feature of said housing.

45. The after-market stop of claim 44, wherein said guided movement of said post from position “A” to position “C” comprises movement of said post up an inclined surface and over a first vertical face to a position “B”, said position “B” being a post position beyond said first vertical face and corresponding to said tumbler retracted position as a result of said toggling of said tumbler first end; and wherein when said tumbler first end is no longer being toggled, biasing of said tumbler causes said post to move back towards position “A” and contact said first vertical face, said first vertical face guiding movement of said post away from position “A” and down a second vertical face to be in position “C,” said first vertical face transitioning into said curved vertical face.

46. The after-market stop of claim 45, wherein said selective contact of said post with said contoured feature of said housing comprises further guided movement, said further guided movement comprising movement from said position “C” back to said position “A”; said further guided movement from position “C” to position “A” comprising movement of said post over a third vertical face and down a second inclined surface into a position “D,” said position “D” being a post position corresponding to said tumbler retracted position resulting from further toggling of said tumbler first end; and wherein when said first end is no longer being toggled, biasing of said tumbler causes said post to move up said second inclined surface and down a fourth vertical face to be in said position “A,” said third vertical surface guiding movement of said post away from said position “C” and toward said position “A.”

47. A method for installing a travel-limiting stop to inhibit full travel of a sliding sash member relative to a master frame that slidably supports said sash member, said method comprising:
moving said sash member in said master frame from a closed position into a partially open position which is defined by the most extreme travel to be permitted by said stop;
measuring a height difference between said sliding sash member and an inward facing surface of said master frame to be used in mounting said stop;
toggling a stop to place said tumbler into said first position;
when required by said measured height difference, removably attaching one or more spacer blocks onto said stop, wherein a total thickness of said one or more spacer blocks is approximately equal to said mounting flange offset minus said measured height difference plus a minimal clearance amount;
placing said stop upon one side of said master frame whereby said mounting flange bottom surface contacts said inward facing surface of said master frame, with said tumbler second end being adjacent to a side surface of said master frame, and with said tumbler bearing surface at said second end being proximate to an inner rail of said sliding sash member;
checking to see if said sash member is free to travel past said housing of said stop while being inhibited by said bearing surface of said second end of said tumbler;
securing said stop to said master frame at said travel-limiting position using one or more mechanical fasteners.

48. The method of claim 47, wherein a second stop is secured to the opposite side of said master frame at said partially opened position, said second stop being manufactured and assembled to be a mirror image copy of said first stop, said second stop be secured to said master frame the same as said first stop in claim 50.

49. A method for creating multiple travel limited positions for a sliding sash member of a sash window assembly or a sash door assembly, said sash member being slidable relative to a master frame of said assembly, wherein said sash window or door assembly is already manufactured, said method comprising:
(a) moving said sash member in said master frame from a closed position into a first travel-limited position at which said movement of said sash member is to be limited by a first stop;
(b) measuring a height difference between said sliding sash and an inward facing surface of said master frame to be used in mounting said stop;
(c) toggling said first stop to pivot said tumbler into said first position;
(d) when required by said measured height difference, removably attaching one or more spacer blocks onto said first stop, wherein a total thickness of said one or more spacer blocks is approximately equal to said mounting flange offset amount minus said measured height difference;
(e) placing said first stop upon said master frame whereby said mounting flange bottom surface contacts said inward facing surface of said master frame, with said tumbler second end being adjacent to a side surface of said master frame, and with said tumbler bearing surface at said second end being proximate to an inner rail of said sliding sash member;
(f) checking to see that said sash member is free to travel past said housing of said first stop while being inhibited by said bearing surface of said second end of said tumbler;
(g) securing said first stop to said master frame at said first travel-limiting position using mechanical fasteners;
(g) toggling said first stop into said second position and moving said sash member to a second of said multiple travel limited positions at which said movement of said sash member is to be limited by a second stop, and repeating the respective steps of (e) through (g) performed for said first stop on said second stop;
(h) repeating step (g) for each remaining position of said multiple travel limited positions.
